(19) United States
(12) Patent Application Publication
(10) Pub. No.: US 2005/0069847 A1
(43) Pub. Date: Mar. 31, 2005

(54) Method and apparatus for completing a research and writing project

(76) Inventor: Wendy Y. Carter, Tempe, AZ (US)

Correspondence Address: SANDRA L. ETHERTON;ETHERTON LAW GROUP, LLC, PO BOX 27843, TEMPE, AZ, 85285-7843, US

(21) Appl. No.: 10/735,391

(22) Filed: Dec. 11, 2003

Related U.S. Application Data
(60) Provisional application No. 60/507,047, filed on Sep. 29, 2003.

(51) Int. Cl. G09B 5/00

(52) U.S. Cl. 434/169

(57) ABSTRACT

A method and apparatus for completing a large research and writing project. The invention comprises an instructing portion, an interactive portion and a motivation portion. Through the use of intuitive interface elements, the instructing portion instructs the author how to choose a writing topic, how to research the topic, how to manage the project, how to process the writing of the project, and, in the case of graduate writing projects, how to choose an academic advisor and how to defend a thesis or dissertation. The instructing portion enables the author to quickly and easily construct a plan and strategy to complete any writing project. The interactive portion provides motivation to the author and a means for the author to query others about the writing project and process. The motivation portion provides various actions to motivate an author to diligently pursue the completion of the writing project. The invention provides a customizable calendar, templates, a budget tool, checklists, and a methods journal.

### CROSS-REFERENCE TO RELATED APPLICATIONS

The present application claims priority to related U.S. Provisional Patent Application No. 60/507047, filed Sep. 29, 2003.

### FIELD OF INVENTION

This invention relates to a method and apparatus for completing a large research and writing project. More specifically, this invention relates to an interactive method for providing instruction and implementing actions within a calculated timeframe to complete a thesis or dissertation.

### BACKGROUND

Of all the Ph.D. candidates enrolled in graduate programs across the U.S. at a given time, it is estimated that approximately only twenty-one percent will complete the program. Several factors account for this problem, however systematic solutions and support systems are largely unavailable. Those that are available are antiquated and limited in approach. There are a few books on the market, but thesis and dissertation students tend not to want to have to read another book. A number of non-interactive websites exist with a substantial amount of information that must be read by just scrolling down from one page to the next. The reader must absorb pages and pages of information without a succinct plan of action at the end. What's more, much of the information is focused on only the writing of the thesis or dissertation. This approach often ignores a practical plan of action and neglects the lack of emotional support that tends to derail students from completing the process. It would be desirable to have a modern, comprehensive, well-defined approach to completing a graduate writing project.

The process of obtaining a postgraduate degree is different from the process required to obtain an undergraduate degree. As a general matter, acquiring the undergraduate degree is similar to the high school experience in that the program is structured. If a student attends class on a daily basis and satisfactorily completes a set of prescribed courses, then the student will graduate. An undergraduate student has the benefit of a syllabus that outlines assignment completion dates and guides him or her through the required coursework for the semester. Thus, from the first day of instruction the student knows what is required to finish the course. As an undergraduate, if a student completes the coursework, the student earns a degree. Hence, the process is defined and somewhat comparable to the high school format where every hour of every day was prearranged for the student.

Pursuing a postgraduate degree is quite different. According to LaPidus (1989), graduate education consists of three major components; it is advanced, focused and scholarly. Because the student and the coursework are beyond the undergraduate level they are both considered “advanced.” Typically the coursework at the graduate level is focused in a particular academic discipline, as opposed to encompassing some general education courses like those found at the undergraduate level. Traditional postgraduate programs require a student to write an integrative, scholarly research paper that is often a capstone requirement for the degree. The research paper must involve an original thesis or idea that makes an original contribution to the student's major or academic discipline. At the masters' level, the thesis research provides an opportunity for the student to become a well-informed and critical consumer of research in his or her field of scholarship. At the doctoral level, the dissertation provides the student with an apprentice-like opportunity to become a contributor to the advancement of knowledge in his or her academic discipline (Council of Graduate School; Distance of Graduate Education: Opportunities and Challenges, pg. 22). The purpose of writing the document is to help train the student to think clearly, critically analyze, conceptualize, explain, defend, debate, and communicate his or her findings in a written and oral format.

Theses and dissertations are analytical documents that provide an answer to a research question of students' own choosing. They must be original work and must contribute to the field in which the student now belongs. The writing projects must follow a particular format and a particular style of writing, and must include a certain number of chapters or pages. Most important, a committee must agree that the paper has met all of the requirements to be called a thesis or dissertation. It would be desirable to provide a method for researching and writing theses and dissertations, and other large writing projects, which are referred to hereinafter as writing projects.

The most challenging part of graduate school, namely the writing project, begins when the structured portion (i.e., the course work) is completed. This unstructured part is unfamiliar to the student and is often the most difficult. The student often feels as if he or she has lost his or her job because there is no place to report on a daily basis. There are no deadlines or penalties set by third parties anymore. The student must be self-motivated, self-organized, and set his or her own deadline as to when the student wants to finish the degree. As a result of this uncertainty and lack of structure, many students do not complete the writing project and leave school without completing the masters or Ph.D. degree. Many are left in limbo status of being labeled “ABD: All but dissertation or all but done.” It would be helpful to have a systematic method of completing such a writing project.

Unfortunately, finding real and practical assistance to achieve the goal of earning a postgraduate degree is nearly impossible. In graduate school, the support available to help students includes the student's spouse and family, the advisor, the graduate secretary, friends, outside dissertation coaches (personal consultants) and books on the subject. However, even a well-meaning and encouraging spouse can only be but so helpful. The spouse will be competing for the time and affection they are entitled to since they are suffering through the process along with the graduate student. In addition, finding a professor who has the time or inclination to assist is a hit-or-miss proposition. If the student finds a professor with similar areas of interest, the professor will often recruit the student to do his or her (the professor's) work for him. While the student might find this work interesting, it competes with the time the student could be spending completing his or her degree requirements.

Dissertation coaches are hard to come by and are expensive. Coaches charge thousands of dollars a year or more to guide graduate students through the entire academic process. After the coursework is over, writing the research document can take over a year to complete because of competing issues in the student's life, the lack of structure at this phase in the graduate school process and a lack of resources, such as time and money.

In addition to the lack of resources, graduate students do not receive the necessary psychological support from the academic institution to complete the degree. As a rule, the feedback that students in graduate school receive is negative. An “old school” attitude prevails among professors, committee members and academic advisors, which includes the belief that part of the learning process is figuring out the learning process itself. However, “figuring it out” can be a time consuming, isolating, and lonely process which could lead to many months of procrastination. Further, professors evaluate students' work often by only pointing out what a student has done wrong. The student is left to assume that if the professor did not say anything, then his or her work must be satisfactory. In graduate school, the student must be self-motivated and be capable of rewarding himself after a hurdle has been mastered.

Moreover, the advisor went through the same process without much assistance from his or her advisor when he or she attended graduate school. Therefore, the tradition of completing a thesis or dissertation is a lonely process and the unsympathetic advisor does not want to cheat the student out of having the same experience he or she suffered through years ago. Hence, the academic advisor will only supervise the student's research and writing project. He or she will not be the student's friend, therapist, financial aid counselor or marital advisor. Even the best academic advisor does not have the time to hold a student's hand throughout the graduate program. The academic advisor's time is limited because, after all, he or she is a professor first and is getting paid to teach courses, advise graduate students, supervise graduate research, write books or journal articles, and serve on campus- and university-wide committees. It would be desirable to provide a method of motivating and supporting a graduate student in completing his or her capstone writing project.

The reason most often cited by students for failing to complete a graduate program is lack of time. Many students enroll in graduate school thinking that writing the writing project is just an extension of the undergraduate experience, thereby underestimating the level of commitment needed to complete the program. Many are blindsided by the amount of independence they have and have no idea or experience with how to handle this new freedom. Often, graduate students act as if they have all the time and money in the world to obtain the degree. However, to complete the degree, a graduate student must diligently research, write and often defend the thesis or dissertation.

To compound the problem, as graduate students mature, many things in their lives compete for their time. They often come to graduate school with outside responsibilities that they did not have as undergraduates. For example, because graduate students are often older at the time of enrollment; they often are at different stages in life. Some are engaged. Some are married. Some are engaged or married with children. Some are single. Some are single with children. Some work in full- or part-time jobs. As a result, work, family commitments and other distractions take time away from the priority of academic work. Hence, they do not have the same amount of free time to complete their academic responsibilities as they once had. Unfortunately, in academic circles, taking too much time to complete a writing project is seen as a weakness. If a student does not meet various academic requirements in a timely manner, the student may be in jeopardy of losing his or her funding. Worse, the student may lose the respect of his or her advisor, who has direct input on the student's graduation. The sooner the student completes the degree requirements, the better.

Clearly, then, time management is a significant factor in completing a graduate program and, more specifically, a writing project. It would be desirable to have a systematic method that assists a graduate student in identifying, organizing and planning when each step of the project is to be completed and motivating the student to complete the steps at the planned time.

Running out of financial resources is another reason a student may not complete his or her graduate degree. The longer a student is in graduate school, the more it will cost. Yet some graduate schools require that the student be continuously registered throughout the writing of the thesis or dissertation. This not only increases the total cost of getting a graduate degree, but forces many graduate students to work part-time to cover the cost of the tuition. This, in turn, reduces the time available to spend on the graduate program; so, many graduate students do not attend graduate school on a full-time basis. This forces the program to take longer, and a vicious circle of too little time and too little money ensues. In addition to tuition, the cost of the thesis or dissertation portion of the degree can be surprisingly expensive. Computer equipment and copy costs can be thousands of dollars alone. It would be desirable to provide a method for graduate student to budget appropriately for the research and writing portions of their degree.

The process of completing a master's thesis or dissertation can be daunting and seemingly impossible. There is a need for a system or method that provides affordable and practical assistance to students to achieve the goal of earning a postgraduate degree. Therefore, it is an object of this invention to provide systematic method of completing a large writing project, particularly a thesis or dissertation. It is another object to provide a system that assists a graduate student in breaking down the writing project into manageable tasks. It is another object to provide a system that assists a graduate student in planning when each step of the writing project is to be completed and completing the steps at the planned time. It is also an object to provide a method that supports and motivates an author to complete a writing project. It is a further object of this invention to provide a comprehensive instructional method and system, using a calendar-driven component, to motivate authors in planning, researching, organizing and completing a writing project.

### SUMMARY OF THE INVENTION

The present invention is a method and apparatus for completing a large writing project. The invention comprises an instructing portion, an interactive portion and a motivation portion. Through the use of intuitive interface elements, the instructing portion instructs the author how to choose a research and writing topic, how to research the topic, how to overcome writing issues related to writing the project, and, in the case of graduate academic writing projects, how to choose an academic advisor and how to defend a thesis or dissertation. The instructing portion enables the author to quickly and easily construct a plan and strategy to complete any writing project. The interactive portion provides motivation to the author and a means for the author to query others about the writing project and process. The motivation portion provides various actions to motivate an author to diligently pursue the completion of the writing project. The invention provides a customizable calendar, templates, a budget tool, checklists, and a methods journal. The apparatus comprises a central processing unit and related memory and storage capacity to operate the instruction, authoring, and interactive system stored in a computer program.

### BRIEF DESCRIPTION OF THE DRAWINGS

FIG. 1 illustrates the components of the method of the present invention.

FIG. 2 illustrates the component for instructing, including research and

FIG. 3 illustrates the component for interacting.

FIG. 4 illustrates the component for motivating.

FIG. 5 illustrates the component for calculating.

### DETAILED DESCRIPTION OF THE INVENTION

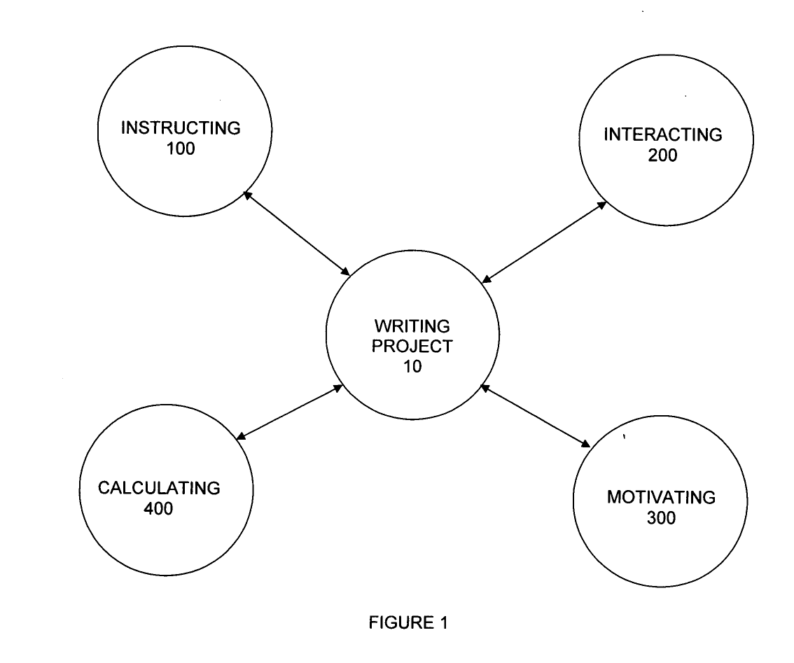

Referring to FIG. 1, the method for completing a writing project 10 comprises instructing 100, interacting 200, motivating 300, and calculating 400. Each of these components is described below in reference to figures that illustrate the general function of each step.

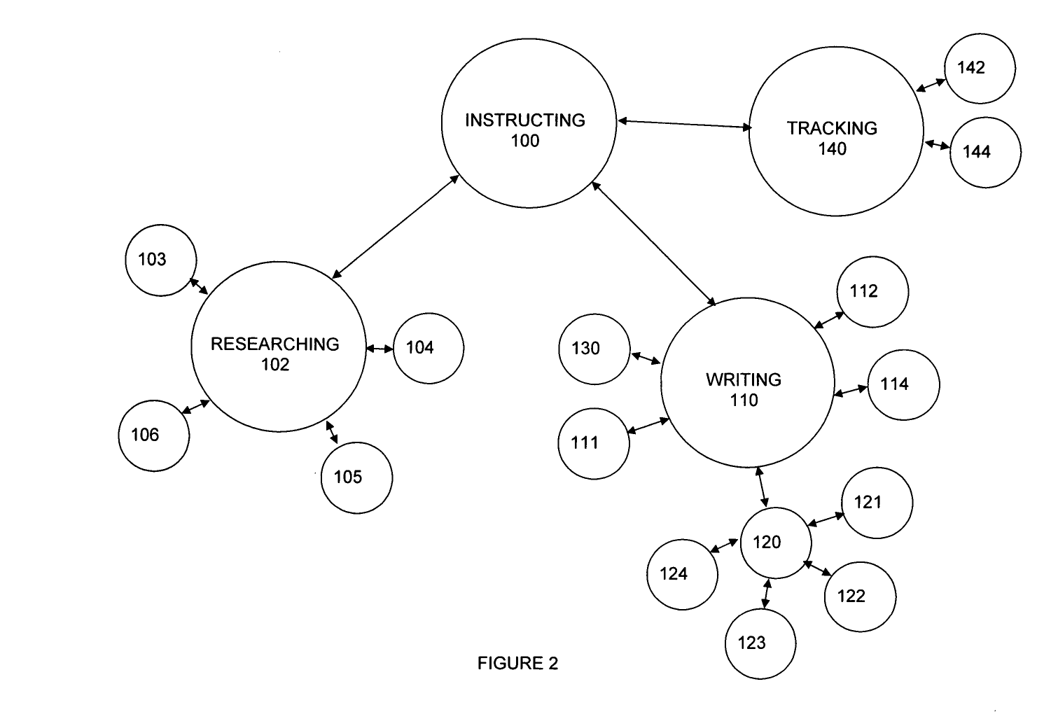

The instructing portion 100 instructs an author about researching 102 and writing 110 a writing project 10. See FIG. 2. The instruction about researching 102 preferably provides a research strategy 103, which further preferably includes information on how to conduct research, how to check sources for credibility, and guidance on how to only take notes once. Lists of resources may be provided along with links to Internet websites for actual research. This instruction also preferably provides offline methods of research 104, including how to use a brick-and-mortar library, and online methods of electronic research 105, including methods of using private computer systems as well as the Internet to find desired information. The method may also include a research template 106 to help systematically record, track, assess and evaluate research findings.

The instruction about writing 110 provides instruction about how to write a large writing project 10. The instruction preferably describes choosing a topic 111, which provides questions designed to lead the author through choosing the topic, such as asking whether the topic is interesting to the author, whether it has value to the field of study, etc. Choosing a topic 111 also provides instruction to focus the author on the goal of adding to the knowledge that already exists on the topic, as opposed to inadvertently writing about unfeasible topics and getting off-task.

The instruction about writing 110 preferably describes how to draft a proposal 112. The proposal is essentially the agreement between the author and the committee as to what the writing project will entail. The proposal instructions 112 include a general outline of what the proposal should include and information on what is necessary if a proposal defense is required. A detailed outline of the proposal contents is preferably provided. After the committee approves the proposal, the author then writes the project by following the proposal outline and the committee members' recommendations.

The instruction about writing 110 further includes instruction for overcoming issues related to writing the writing project 114. While writing is the substantial part of completing the thesis or dissertation, the present invention is structured with the understanding that sometimes it is difficult to get started writing and sometimes writer's block is a reality. The writing instruction includes recommendations on how to get started writing and stay focused, how to keep writing, how to edit and proofread, how to overcome writer's block, practical hints to showing tangible progress and organization, helpful information on incorporating the proposal into the first chapters of the thesis or dissertation, and how to deal with comments from committee members. Instruction about writing 110 may also include instructions about common writing mistakes 130 and how to avoid them. Additional instruction provided in this portion may include a list of words and phrases to help the writing style, such as transitional words or synonyms.

If the writing project is an academic document, the instruction about writing a large writing project 10 includes instruction about the academic portion 120. This may include instruction about how to choose an academic advisor 121 or an academic committee 122. For choosing an academic advisor, the instructions include cautioning the author on the importance of the selection of an academic advisor, traits to look for when choosing the advisor, what to expect from an academic advisor, and how to get the most from an academic advisor. For choosing a committee, the instructions include what traits to look for in a committee member, and the specific roles and functions of the committee members.

The academic portion 120 may also include instructions about defending a writing project 123. The issues preferably include how to schedule the defense, what is to be expected, and how to prepare for the defense. The method may also include instructions about depositing an academic writing project 124. This instruction addresses the issues surrounding finalizing the process, including assessing enrollment requirements, final reviews and signatures, final format processes, deposits, binding, etc.

To further organize the approach for completing a large writing project, the invention provides several means for tracking 140 the author's progress. A systematic approach checklist 142 may be provided. This type of checklist provides an overview of the process, as well as individual steps that can be checked-off by the author. Preferably the steps are presented in a recommended order of completion. Another aid contemplated that may be provided to the author is a journal 144 that enables the author to record, track, and assess his or her progress. Progress may also be recorded on a fillable calendar 410, explained below.

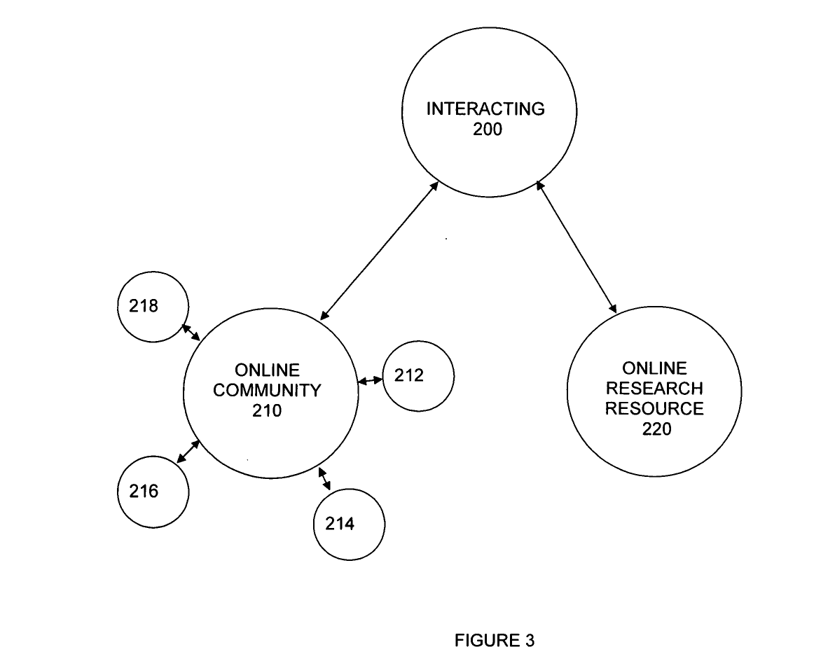

The interacting portion 200 provides means for an author to ask questions or provide input and receive information in return. See FIG. 3. The interaction is preferably provided through an online community 210 and an online research resource 220. The online community 210 is accessed through a computer. One aspect of the online community 210 enables an author to email an online advisor 212 and receive a response. Preferably the online advisor 212 is a person having expertise in completing large writing projects who can provide customized assistance to the author. The online community 210 may also include a chat room 214 which is a place or page on a website where people can exchange information with each other by typing messages which are displayed almost instantly on the monitors of others who are also participating. Chat rooms are also called online forums or discussion boards. The online community 210 may also include an email newsletter 216 containing information relating to writing projects. Further, the online community 210 may include a database of answers to frequently asked questions 218. Preferably each component of the online community 210 would provide access to information related to completing a large writing project, such as a thesis or dissertation. Access to the online community may be provided on a subscription basis, and access may require a password to participate.

The interacting portion 200 may also include access to an online research resource 220, such as proprietary database relating to the author's topic, general research services such as LexisNexis, Bureau of Labor Statistics, Hoovers, Library of Congress, Reuters, Educational Resource Information Center, etc. As with access to the online community may be provided on a subscription basis and access may require a password to participate.

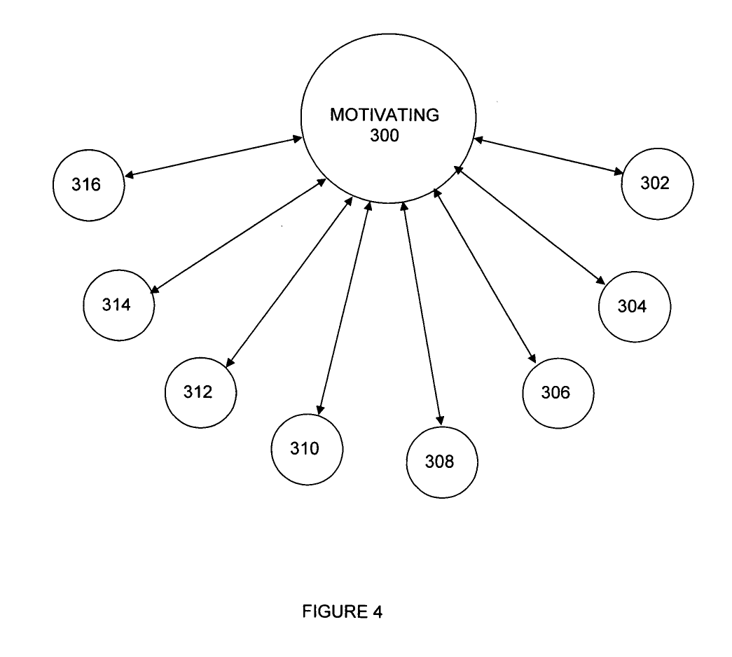

The motivating portion 300 provides means for motivating author. See FIG. 4. Motivating may include a commitment contract 302, in which the author states that he or she commits to finishing the writing project by a given completion date 404, and that the author commits to taking action for at least twelve minutes a day to move the writing project forward. The contract may include other commitments, such as getting adequate sleep, diet, exercise, and personal rewards. The agreement is preferably with the author himself—a self-commitment contract—but the agreement may also be made with another person. Motivation preferably also includes a list of rewards 304 the author may receive upon completion of a portion of the writing project, such as completing a writing task, meeting a deadline, or keeping a commitment to himself. For example, upon finishing a chapter, the author may reward himself by going to see a movie or having coffee with a friend. Motivating may also include a list of energy boosters 306, such as exercising or taking scheduled breaks. Motivating may also include a list of incremental steps 308 to take to complete the writing project 10, including writing and non-writing tasks. The purpose of listing non-writing tasks is that even if the author cannot write on a given day, that there are plenty of other required tasks that need to be accomplished that can show daily progress toward the goal of completing the thesis or dissertation. For those times when the author has writer's block, motivating may also include a list of solutions to overcome common writing roadblocks 310. The method may also include a mock diploma 312, providing a visible reminder of the goal the author is seeking.

Another step in motivating is for the author to obtain support 316 from others in completing the writing project. These issues preferably include how to identify when to ask for help, understanding the role of a coach, how to choose a coach, and where to look for support on the Internet.

Finally, motivating preferably includes a list of common mistakes 314 that frustrate and slow completion of the writing project so that the author can voice them. The list may include issues such as being respectful of your committee, staying enrolled at the university until the thesis or dissertation is complete, sticking to the proposal, backing-up your work on computer disk, and not missing any milestone.

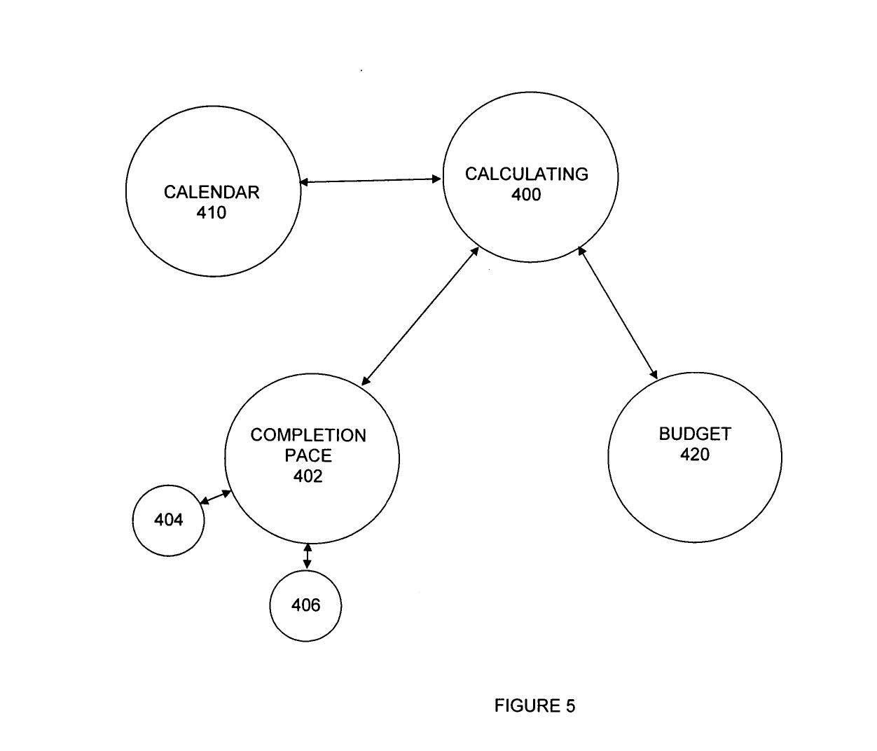

The calculating component 400 provides an interactive calculation for various dates and a budget associated with completing the writing project. See FIG. 5. Writing projects typically have a required length 406, set by the receiving party, such as the academic advisor or the publisher. Length can be measured in pages, words, file size or other units, but is preferably measured in chapters. Writing projects also typically need to be completed by a specific date, whether set by the receiving party or determined the author. This component provides issues that the author may consider when choosing the completion date 404. Once a completion date 404 is selected, a calculation pace 402 is calculated from the completion date 404 and the length 406 of the writing project. In the preferred embodiment, in which the method is implemented on a computer, the system allows the author to input the finish and the start date, and the number of days the author has to complete the writing project is automatically calculated. If a start date is not specified, the current date is assumed. Thus, using the completion date 404 and the given length 406, the method calculates a completion pace 402 for the writing project 10. For example, if on Jan. 1, 2010 an author inputs data indicating that he or she needs to complete a 28-chapter thesis by Mar. 31, 2011, the completion pace will be 2 chapters per month. The author also can calculate even smaller milestones, such as the number of pages that need to be written per day. Assume for the calculation an average of twenty pages are written per chapter and that an additional twenty pages is required for front and back matter. The calculation is as follows: Total number of pages in thesis or dissertation is equal to the number of chapters times twenty pages per chapter; pages per day that need to written by the author is equal to the total number of pages calculated divided by the total number of days to finish thesis or dissertation. The interactive calculation preferably also provides how often the author needs to start a new chapter.

In addition to providing the interactive calculations, calculating 400 also preferably provides a personalized, fillable calendar 410. The start and finish dates entered by the author are automatically entered into the calendar. Further, the dates that a new chapter is to be started, as previously calculated, are also automatically entered. The calendar may also let the author enter notes and dates of other events.

Calculating 400 also includes interactive means for calculating a budget 420 for the writing project. The interactive budget calculator enables the author to input estimated costs for purchases necessary to complete the writing project. Certain costs are common to all writing projects, and the system may have default values for those items, or may request those costs specifically. Costs for a writing project may include computer hardware and software; cost of disks for backup; workspace costs; paper, copy, and binding costs; copyright filing fee, charges editorial assistance, personal rewards, and supplies, etc.

The invention may be provided with text, audio, graphics, or video. In the preferred embodiment, in which the method is implemented on a computer, the invention is provided in an interactive format, which accepts and responds to input from the author through typed commands, voice commands, mouse clicks or other means of interfacing. For electronic versions of the forms, preferably the lists are fillable and printable. That is, the author can add items or notes to the lists and then print them out.

Preferably the method described herein is provided to the author on a computer-readable storage medium, such as a CD or DVD. In such case, data on the storage medium is read by a computer and visual outputs are displayed on a display device, such as a common computer monitor. Audio portions may also be audio displayed. It is contemplated that the method could also be provided to multiple authors in a client-server network or via the Internet. In such case, the method would be transmitted from a central computing device to multiple remote displays or computer devices via a communication relay. Communication relay preferably includes or is embodied in the Internet in its various forms and definitions, including e-mail and other communication mechanisms. Of course, the invention contemplates using future generations of the Internet, e-mail communication systems and other new forms of electronic communication that may arise.

The preferred embodiment of this invention is a method and apparatus for assisting a graduate student in completing his or her thesis or dissertation. However, under appropriate circumstances, the method and apparatus provided herein may be used to assist other authors, such as journalists, students, academic professors, law students, or novelists, in completing a comprehensive writing project.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

1. A method for assisting an author to complete a writing project of a given length, the method comprising:
a) instructing the author about researching the topic; and
b) instructing the author about writing about the topic.

2. The method of claim 1 wherein instructing the author about researching the topic further comprises:
a) providing a research template; and
b) providing research strategies.

3. The method of claim 1 further comprising:
a) providing access to an online community.

4. The method of claim 3 wherein the online community comprises at least one of an online advisor, a chat room, or an email newsletter.

5. The method of claim 1 further comprising:
a) motivating the author.

6. The method of claim 5 wherein motivating the author further comprise providing at least one of:
a) a commitment contract;
b) a list of rewards the author receives upon partial completion of a portion of the writing project;
c) a list of energy boosters;
d) a list of incremental steps to take to complete the writing project.
e) a list of solutions to overcome common writing roadblocks; and
f) a mock diploma.

7. The method of claim 1 further comprising:
a) calculating a completion pace for the writing project using a completion date specified by the author and the given length.

8. The method of claim 7 further comprising:
a) calendaring the completion date.

9. The method of claim 1 further comprising:
a) calculating a budget for the writing project using expenses estimated by the author.

10. The method of claim 1 wherein the writing project is a thesis or dissertation and instructing the author about writing about the topic further comprises at least one of:
a) displaying instructions about choosing an academic advisor;
b) displaying instructions about choosing an academic committee;
c) displaying instructions about defending the writing project; and
d) displaying instructions about depositing the writing project.

11. The method of claim 1 further comprising:
a) providing access to an online research resource.

12. The method of claim 1 further comprising:
a) providing a journal.

13. A method for assisting an author complete a writing project of a given length, the method comprising:
a) instructing the author about:
i. choosing a topic;
ii. choosing an academic advisor;
iii. choosing an academic committee;
iv. researching the topic;
v. writing a proposal;
vi. writing about the topic;
vii. defending the writing project;
viii. depositing the writing project;
b) calculating a completion pace using a completion date specified by the author and the given length.

14. The method of claim 13 further comprising:
a) calculating a budget for the writing project using expenses estimated by the author.

15. The method of claim 13 further comprising:
a) providing access to an online research resource.

16. The method of claim 13 further comprising:
a) providing access to an online community.

17. The method of claim 16 wherein the online community comprises one of an online advisor, a chat room or an email newsletter.

18. The method of claim 13 wherein instructing the author about researching the topic further comprises:
a) providing a research template; and
b) providing research strategies.

19. A method for assisting an author to complete a writing project, the method implemented on a computer having a processing unit, a memory means, a display means, and an input means, the method comprising:
a) displaying instructions about researching a topic; and
b) displaying instructions about writing about the topic.

20. The method of claim 19 wherein displaying instructions about researching the topic further comprises:
a) displaying a research template; and
b) displaying research strategies.

21. The method of claim 19 wherein displaying instructions about writing about the topic further comprises:
a) displaying instructions about choosing a topic for the writing project; and
b) displaying instructions about writing a proposal.

22. The method of claim 19 wherein the writing project has a given length, the method further comprising:
a) calculating a completion pace using a completion date and the given length input by the author.

23. The method of claim 22 wherein the completion pace is measured in number of chapters, the method further comprising:
a) displaying the number of chapters that should have been completed by the current date according to the completion pace.

24. The method of claim 19 further comprising:
a) calculating a budget for the writing project using estimated expenses input by the author.

25. The method of claim 19 wherein the writing project is a thesis or dissertation and displaying instructions about writing about the topic further comprises at least one of:
a) displaying instructions about choosing an academic advisor;
b) displaying instructions about choosing an academic committee;
c) displaying instructions about defending the writing project; and
d) displaying instructions about depositing the writing project.

26. The method of claim 19 further comprising:
a) providing access to an online community.

27. The method of claim 26 wherein the online community comprises at least one of:
a) an online advisor
b) a chat room or an
c) email newsletter.

28. The method of claim 19 further comprising providing motivation to the author with at least one of:
a) a commitment contract;
b) a list of rewards the author receives upon completion of a portion of the writing project;
c) a list of energy boosters;
d) a list of incremental steps to take to complete the writing project.
e) a list of solutions to overcome common writing roadblocks; and
f) a mock diploma.

29. The method of claim 19 further comprising providing a journal.

30. A method for assisting an author to complete a writing project comprising:
a) providing an instructing portion; and
b) providing an interactive portion.

31. The method of claim 30 wherein the providing an instructing portion 100 further comprises:
a) providing instructions for researching a writing project; and
b) providing instructions for writing a writing project.

32. The method of claim 31 wherein the instructions for researching a writing project comprise:
a) providing a research template; and
b) providing research strategies.

33. The method of claim 31 wherein the instructions for writing a writing project comprise:
a) providing instructions about choosing a topic for the writing project;
b) providing instructions about writing a proposal;
c) providing instructions about writing about the topic; and
d) providing instructions about calculating a completion pace using a completion date specified by the author and a length of the writing project specified by the author.

34. The method of claim 30 further comprising:
a) providing instructions about calculating a budget for the writing project using expenses estimated by the author.

35. The method of claim 30 further comprising one or more of:
a) providing instruction about completing one or more non-writing tasks; and
b) providing instruction about common writing mistakes.

36. The method of claim 31 wherein the writing project is a thesis or dissertation and providing instructions about writing about the topic further comprises:
a) providing instructions about choosing an academic advisor;
b) providing instructions about choosing an academic committee;
c) providing instructions about defending the writing project; and
d) providing instructions about depositing the writing project.

37. The method of claim 31 wherein providing instructions about writing about the topic further comprises:
a) providing motivation to author with at least one of:
i. a commitment contract;
ii. a list of rewards the author receives upon completion of a portion of the writing project;
iii. a list of energy boosters;
iv. a list of solutions to overcome common writing roadblocks; and
v. a mock diploma.

38. The method of claim 30 wherein the providing an interactive portion further comprises:
a) providing access to an online community.

39. The method of claim 38 wherein the online community comprises at least one of an online advisor, a chat room or an email newsletter.

40. The method of claim 30 further comprising:
a) providing access to an online research resource.

41. The method of claim 30 further comprising providing motivation to the author with at least one of:
a) a commitment contract;
b) a list of rewards the author receives upon completion of a portion of the writing project;
c) a list of energy boosters;
d) a list of small steps to take
e) a list of solutions to overcome common writing roadblocks; and
f). a mock diploma.

42. The method of claim 30 further comprising providing a journal.

43. An article of manufacture comprising:
a) a computer-readable medium; and
b) data stored in the computer readable medium comprising:
i. for writing a writing project of a given length;
ii. instructions for calculating a completion pace of the writing project from a completion date and the given length.

44. The article of manufacture of claim 43 wherein the data stored in the computer readable medium further comprises means for calendaring the completion date.

45. A computer program product comprising:
a) instructions for researching a writing project;
b) instructions for writing the writing project;
c) providing an online community; and
d) providing motivation to the author.
